(19) United States
(12) Patent Application Publication
(10) Pub. No.: US 2007/0147394 A1
(43) Pub. Date: Jun. 28, 2007

(54) METHOD AND APPARATUS FOR PROCESSING TIMERS

(76) Inventor: Keith Iain Wilkinson, Fremont, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/467,037

(22) Filed: Aug. 24, 2006

Related U.S. Application Data
(60) Provisional application No. 60/752,836, filed on Dec. 22, 2005.

(51) Int. Cl. H04L 12/56

(52) U.S. Cl. 370/398

(57) ABSTRACT

A timer for processing timer entries in an efficient manner utilizing linked lists, without requiring a walk-through to add new timer entries. Timer entries are added to a linked list only at its tail. Each linked list has an associated timer size. In one embodiment, a timer entry is added only to a linked list having a timer size matching the expiration time of the timer entry. In other embodiments, a timer entry is added to a linked list having the greatest timer size not exceeding the expiration time of the timer entry. When a timer entry is added to a linked list, its expiration time is reduced by the timer size of the linked list, and a time-to-live value is set such that the sum of all time-to-live values of timer entries in the linked list equals the timer size.

### RELATED APPLICATIONS

This patent application claims the benefit of priority, under 35 U.S.C. Section 119(e), to U.S. Provisional Patent Application Ser. No. 60/752,836, filed on Dec. 22, 2005, the entire content of which is incorporated herein by reference.

### FIELD

Embodiments of the present application relate to a method and apparatus for manipulating data structures, and more particularly, to data structures for keeping track of a plurality of timers in an efficient manner.

### BACKGROUND

In many packet-based communication systems, it is necessary to set a multiple number of timers. For example, for many communication systems, if a packet is transmitted, then a timer is set to expire at a certain time. If an acknowledgement for that packet is not received within the expiration time for that timer, then some action will be taken, such as, for example, retransmitting the original data packet.

FIG. 1 illustrates a data structure for setting up a multiple number of timers. This data structure may be referred to as a timer 100. This timer comprises a linked list of objects (or timer entries) labeled 104, 106, 108 and 110. This linked list may be referred to as a timer list. Each object in the linked list may be referred to as a timer entry. Each timer entry comprises a time value indicative of when that timer is set to expire, and is referred to as a time-to-live value. A timer entry may comprise other values or data structures, which may refer to various actions that should be taken if the timer entry expires.

Timer entry 104 is the head timer entry of the linked list and timer entry 110 is the tail entry of the linked list. A time-to-live value is relative to the timer entry that precedes it. An exception to this rule is that for the head timer, its time-to-live value is relative to the current time. To illustrate this, in FIG. 1 examples of time-to-live values are indicated, where the time-to-live values for timer entries 104, 106, 108 and 110 are, respectively, 30, 10, 10, and 5 time units. For simplicity of discussion, assume the unit of time is a second. For this example, timer entry 106 is set to expire 10 seconds after head timer entry 104 is set to expire. Similarly, timer entry 108 is set to expire 10 seconds after timer entry 106 is set to expire and, finally, tail timer entry 110 is set to expire 5 seconds after timer entry 108 is set to expire. Because head timer entry 104 has no timer entry that precedes it, its time-to-live value is relative to the current time, so that it is set to expire 30 seconds from the current time.

Register file 102 comprises two pointers. A timer list head pointer pointing to timer head entry 104 and a timer list tail pointer pointing to tail timer entry 110. The process that updates this timer list decrements the time-to-live value in the head timer entry 104. Once its time-to-live value reaches zero, it has expired, and some action is taken, depending upon some value or data structure stored associated with the expired time entry.

The timer list structure in FIG. 1 is a doubly linked list so that, except for the head and tail, each timer entry has a pointer that points to the timer entry that precedes it and another pointer that points to the timer entry that comes after it. The head timer entry has a pointer that points to the time entry that comes after it, and the tail timer entry has a pointer that points to the time entry that precedes it. These pointers facilitate adding a new timer entry to the timer list. For example, continuing with the example time-to-live values in FIG. 1, suppose a new timer entry is to be added which is set to expire 45 seconds from the current time. To find out where that timer entry should be inserted, the process maintaining the timer list steps through the timer list and accumulates the actual expiration time for which each timer entry that it steps through. When an expiration time is calculated that exceeds the expiration time value for that new timer entry, then the process has identified where to insert the new timer entry.

For example, continuing with the example illustrated in FIG. 1, suppose a new timer entry has an expiration time of 45 seconds from the current time. Starting with the head timer entry 104, as the process steps up the list to timer entry 106, the total accumulated time is the time-to-live value for the head timer 104 plus the time-to-live value for the timer entry 106, which is 40 seconds. Going up the list, the process then adds the time-to-live value of the timer entry 108 to that accumulated sum to obtain 50 seconds. Because 50 seconds exceeds 45 seconds, the process identifies that the new timer entry, which is set to expire at 45 seconds from now, should be inserted between the timer entry 106 and the timer entry 108. To do this, various pointers need to be changed. First, a free memory location will be taken from a free list which will be the new memory location for that new timer entry, and the pointer in the timer entry 106, which currently points to the timer entry 108, is changed to point to that new memory location. The pointer in the timer entry 108, which currently points to the timer entry 106, will also be changed to point to that new memory location. Furthermore, pointers in the new timer entry will be created so that they point to the timer entry 106 and the timer entry 108. Of course, if the new timer entry is to fall at the head of the timer list or at the tail of the timer list, then it will be necessary to change the tail pointer in the register file 102.

Maintaining a very large timer list with the data structure as indicated in FIG. 1 may be very time consuming because to enter a new timer entry, it is necessary to step through the timer list and find out where to insert the new timer entry.

### BRIEF DESCRIPTION OF THE DRAWINGS

FIG. 1 illustrates a prior art timer.

FIG. 2 illustrates a timer queue, according to an example embodiment.

FIG. 3 illustrates a timer employing multiple timer queues according to an example embodiment.

FIGS. 4A and 4B illustrate an example time evolution for the timer queue of FIG. 2.

FIG. 5 illustrates a flow diagram of a method, in accordance with an example embodiment, for updating the timer queue of FIG. 2.

FIG. 6 illustrates a timer queue according to an example embodiment.

FIG. 7 illustrates an example time evolution for the timer queue of FIG. 6

FIG. 8 illustrates a flow diagram of a method, in accordance with an example embodiment, for updating the timer queue of FIG. 6.

FIG. 9 illustrates a timer employing multiple timer queues according to an example embodiment.

FIG. 10 illustrates a timer queue according to an example embodiment.

FIG. 11 illustrates a flow diagram of a method, in accordance with an example embodiment, for updating the timer queue of FIG. 10.

FIG. 12 illustrates a timer employing multiple timer queues according to an example embodiment.

FIG, 13 illustrates a computer system employing software which, when executed by the computer, causes the computer to preform any of the methodologies described herein.

### DESCRIPTION OF EXAMPLE EMBODIMENTS

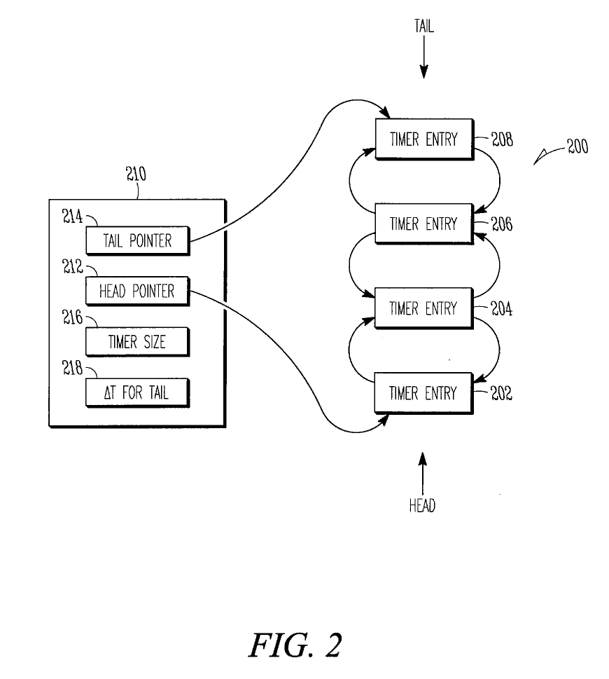

Embodiments of the present application employ a plurality of linked lists to maintain expiration times, but do not require a step-through or walk-through for inserting a new timer entry. Before discussing the general data structure, a data structure with one linked list is first considered. This is illustrated by way of example in FIG. 2, where the linked list is shown to comprise objects 202, 204, 206 and 208. This timer list may be referred to as a timer queue 200 because, as will be seen in the discussion below, a timer list resembles a queue where the first object in is the last object out.

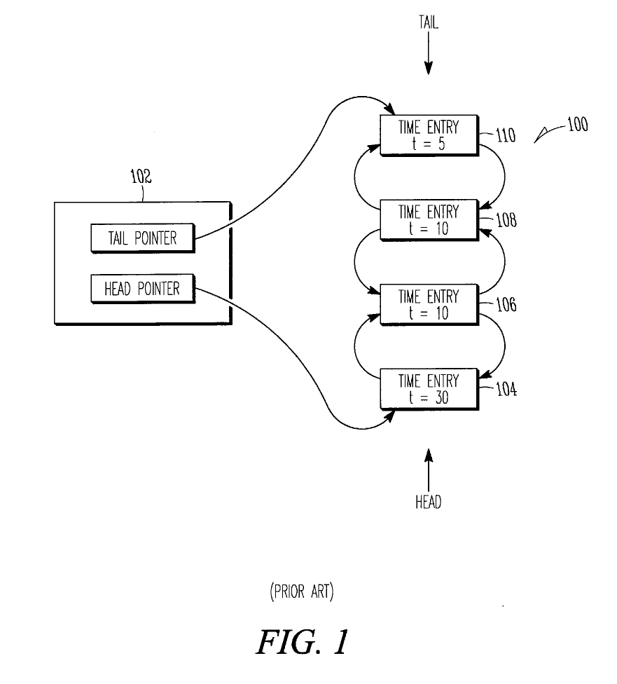

As in FIG. 1, each object in the linked list of FIG. 2 may be referred to as a timer entry. The first object in the timer queue 200 of FIG. 2 may be referred to as a head timer entry, and the last object as the tail timer entry. For example, as in FIG. 1, various time-to-live values are associated with (“stored in”) the various timer entries, where for each timer entry other than the head timer entry, its time-to-live value is relative to its preceding timer entry.

A register file 210 has a head pointer 212 to a head of the timer queue 200, and a tail pointer 214 to a tail of the timer queue 200. But in addition to these pointers, register file 210 also comprises two other entries associated with the timer queue in FIG. 2. One of these entries may be referred to as a timer size 216, and the other entry may be a time value 218 denoted as ΔT.

Example embodiments may place all new timer entries at the tail of a timer queue, thus avoiding a walk-through. For the current discussion relating to FIG. 2, it will be assumed that only those new timer entries having an expiration time equal to the timer size are allowed to enter the timer queue 200. For example, if the timer size is 100 seconds, then the timer queue 200 of FIG. 2 may only be updated with new timer entries that are set to expire in 100 seconds. Other example embodiments for which this restriction is removed will be described later.

Although this restriction serves a pedagogical purpose, it is fortuitous that for the InfiniBand® Architecture, expiration times take on only a limited set of discrete values. InfiniBand is a registered trademark of System I/O, Inc., Suite 217, 5440 SW Westgate Dr., Portland, Oreg., 97221, doing business as the InfiniBand Trade Association. (See www.infinibandta.org.) Specifically, the expiration times for the InfiniBand Architecture are limited to some constant times a power of two, where the exponent of two is anywhere from zero to 31. In this example case, one would have 32 data structures such as that indicated in FIG. 2, where each data structure is for one of the specified timer expirations. Then, when a new timer entry is to be inserted into a timer queue, it must be matched up with that timer queue having a timer size that matches the expiration time of the new timer entry. It is however to be noted that the example embodiments described herein are not limited to the InfiniBand Architecture.

For a timer queue, its associated ΔT for its tail time entry is a number which changes and keeps tract of the actual expiration time at which the tail timer entry is set to expire. By using the data structure of FIG. 2, it is not necessary to perform a walk-through the timer queue in order to insert a new time entry. That is because only timer entries whose expiration times match the timer size are allowed to enter that timer queue, where all new timer entries are placed at the tail end of the timer queue.

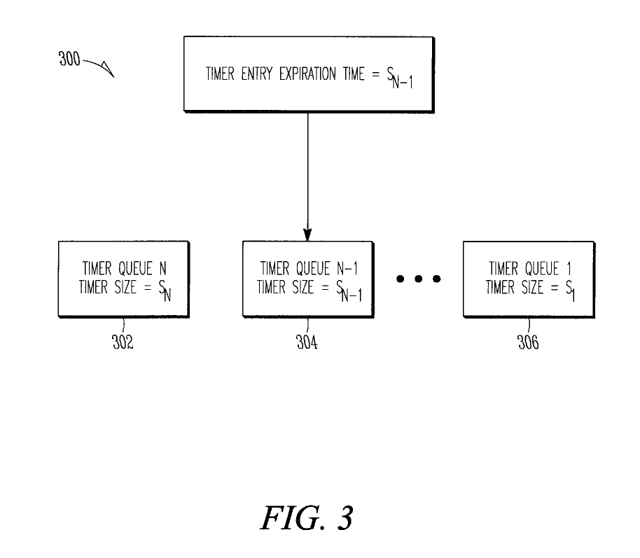

For example, FIG. 3 shows a number of example timer queues 300. For ease of explanation, the detailed structure of each timer queue is not described in detail but is simply represented as a block. Block 302 indicates a timer queue with a timer size SN seconds, block 304 indicates a timer queue with a timer size S_{N-1} seconds, and so forth, with block 306 indicating a last timer queue having a timer size equal to S₁ seconds. Now, suppose a new timer entry is to be inserted, which has an expiration time of S_{N-1} seconds from the current time. That new timer entry is to be placed only in the timer queue indicated by block 304 because its expiration time matches that particular timer size. For a communication system such as the InfiniBand Architecture, the data structure illustrated in FIG. 3, comprising a plurality of timer queues 300, is sufficient because the timer sizes may be chosen such that each new timer entry will have an expiration time that matches exactly one of the timer sizes. Later in this description of example embodiments, the data structure indicated in FIGS. 2 and 3 is generalized so that timer entries of any arbitrary expiration time may be appropriately handled.

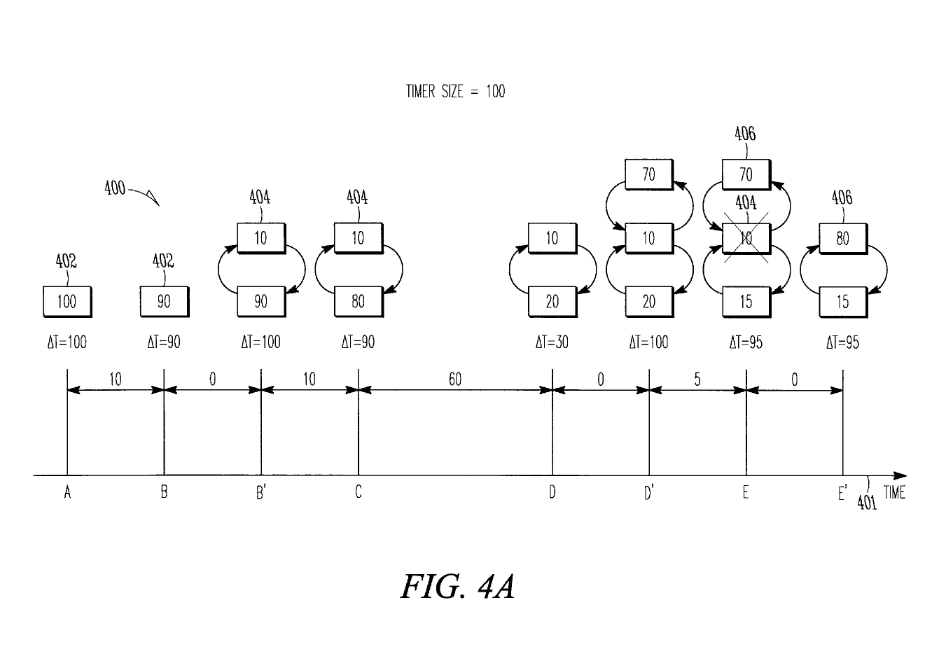

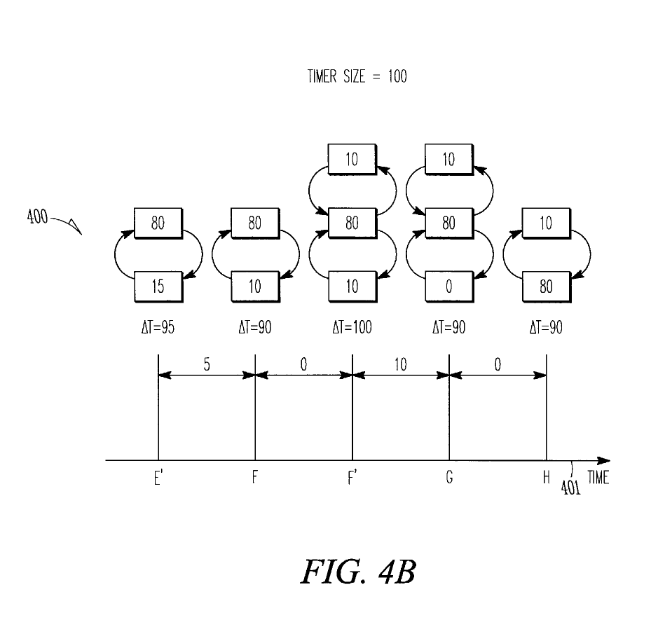

FIGS. 4A and 4B illustrate how the example timer queues 200, 300 of FIG. 2 or FIG. 3 may change as a function of time. In FIG. 4A, a time axis 401 is labeled with various events indicated by a letter. Starting with event A, which shows at this point in time that there is only one timer object 402 in a timer queue 400. Because there is only one object in the timer queue 400 at the time labeled A, it serves both as a head timer entry and a tail timer entry for that timer queue 400. The time-to-live value of this object is shown by way of example to be 100 time units. It will be understood that the time unit is arbitrary, but for ease of discussion let the time unit is chosen to be one second, so that the time-to-live value for the object 402 is 100 seconds. Below the object 402 at time event A is ΔT for the timer queue 400, which is set by way of example to 100 seconds. The timer size for the timer queue represented in FIGS. 4A and 4B is assumed merely by way of explanation to be 100 seconds so that event A may be thought of as an initialization of the timer queue 400 when the first timer entry arrives. Consequently in the given example, at time event A, there is one timer entry set to expire at 100 seconds, and the time-to-live value for the timer entry and the ΔT for the timer queue are accordingly set at 100 seconds.

Considering example event B on the time axis 401 of FIG. 4A. Assuming by way of example that time B occurs 10 seconds after time A. In that case, the time-to-live value for object 402 at time B is now 90 seconds, and accordingly ΔT has also been decremented down to 90 seconds. Now, suppose just after time B, a new entry arrives at time B′. In FIG. 4A, the time difference between time B and time B′ is zero seconds. Of course, this is a simplification (and other arbitrary time period may be applicable in use). It is meant to mean that the new time entry has arrived at time B or later, but before the time-to-live value for time B has been decremented. That is, the process maintaining the timer queue decrements the time-to-live value of the head timer entry at some given rate, but somewhere between the time indicated by B and the next time for which the time-to-live entry is to be decremented by one, a new timer entry arrives which needs to be placed in the timer queue. This new timer entry is indicated by an object 404 at the time event B′.

As stated earlier, it is assumed in the given example that all timer entries that enter a particular timer queue have their expiration time matched to the timer size of that particular timer queue, which in the example of FIGS. 4A and 4B is shown by example to be 100 seconds. The new timer entry indicated by timer object 404 at time B′ is set to expire in 100 seconds from time B′. Accordingly, since its time-to-live value is relative, it is set to 10 seconds, because at the time just before B′ (time B) ΔT is 90 seconds. When the timer queue 400 is updated at time B′, ΔT at time B′ must be reset to the timer size, which is 100 seconds. Now, suppose 10 more seconds elapse, which brings us in the given example to time C. In this case, the example time-to-live value for the head timer entry has been decreased by 10 seconds down to 80, and ΔT has also been decreased by 10 seconds from 100 seconds down to 90 seconds. But the time-to-live entry for the tail timer entry, which is shown as timer object 404 at time C, is still at 10 seconds because it is relative to the head timer entry.

Now, suppose 60 seconds have elapsed between the time indicated as C and the time indicated as D. Then, the time-to-live value of the head timer entry has been decreased by 60 seconds down to 20, and ΔT has been decreased down to 30 seconds. Now suppose a new timer entry arrives just after the time indicated by D, where this new time is indicated as D′. Again, for simplicity it is indicated that zero seconds have elapsed between times D and D′, which merely means that the new entry has occurred before the time-to-live entry of the head timer entry at time D has been decremented. At time D, ΔT was 30 seconds, which indicates that the tail has 30 seconds until it expires. Accordingly, at time D′, the new time entry should have a timer entry value of 70 seconds so that its timer entry value plus the old ΔT is 100.

Now, consider the time event labeled as E in FIG. 4A. It may happen that a timer entry is to be cancelled because an acknowledgement packet associated with the transmitted packet for that timer entry has been received. In some data structures, such timer entries may not be cancelled, but a list may be made indicating which ones should be ignored when they expired. In other example embodiments, the timer queue may be updated so as to remove any expired timer entries. In the example of FIG. 4A, at time E, let us suppose that the timer entry labeled as 404 at time E is to be cancelled. In this case, the various pointers need to be changed so that the timer entry labeled as timer object 406 at time E now becomes the new tail at time E′. When it becomes the new tail, its time-to-live entry is increased by the time-to-live entry of the expired timer entry. In the example of FIG. 4A, 10 seconds is added to 70 seconds to yield a time-to-live value of 80 seconds, as indicated at time E′.

Now, consider example FIG. 4B, which is merely an extension of example FIG. 4A but separated for ease of illustration. The time event E′ is reproduced on the time axis of FIG. 4B for convenience. Now at time F, five seconds have elapsed, so that the time-to-live entry of the head is reduced down to 10 seconds and ΔT has been reduced to 90 seconds. Now, suppose a new timer entry arrives just after time F, indicated as time F′. This new timer entry is added to the top of the timer queue, its time-to-live value is set to 10 seconds, and ΔT is reset back to the timer size of 100 seconds. At time G, 10 seconds has expired, so that the time-to-live value associated with the head has now decreased down to zero. This indicates that the head timer entry has expired and that some action needs to be taken. It is removed from the timer queue 400 and the next timer entry becomes the new head of that timer queue 400. Note that its time-to-live entry is not relative to a preceding timer entry because it is now the new head of the timer queue. Accordingly, time H shows the new data structure comprising two objects, a head timer entry set to expire in 80 seconds and a tail timer entry set to expire 10 seconds after that, for an expiration time of 90 seconds, which is reflected in ΔT being set to 90 seconds.

Note that at any given time in the example embodiment, the sum of time-to-live values for each timer entry in a timer queue is equal to ΔT.

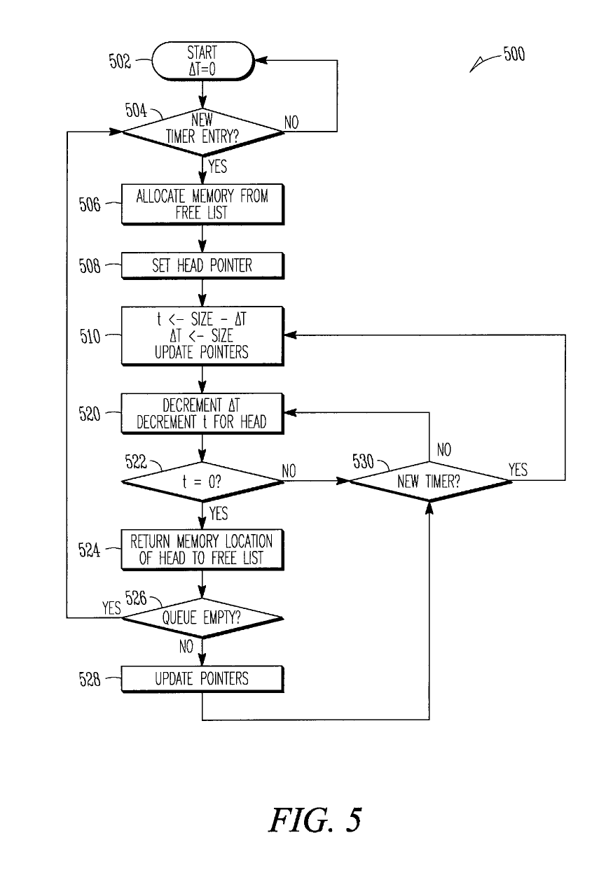

An example flow diagram illustrating a method 500, in accordance with an example embodiment, for maintaining a data structure is shown in FIG. 5. The method 500 may be used for maintaining the data structure of FIG. 2 and, accordingly, is described by way of example with reference thereto. The example method 500 shows an example procedure for adding a new timer entry to the timer queue and removing a head timer entry if it expires. For ease of explanation, regarding FIG. 5, the way in which timer entries are cancelled is not discussed in detail, but it should be clear to a person of ordinary skill in the art and from the above description with respect to FIG. 4A how such a procedure is performed.

In the example method 500 shown in FIG. 5, it is assumed by way of example that initially the timer queue is empty and control is at block 502. Initially, ΔT is set to zero and the pointers are set to some value to indicate that they do not point to any valid memory location, so that the timer queue is indicated as empty. When the first timer entry arrives, control moves to block 504 and then to block 506, where memory for the new timer entry is allocated from a free list. In block 508, the timer queue head pointer is set to point to the allocated memory location, and then control is brought to block 510. The first step in block 510 shows that the time-to-live value, denoted by t, is set equal to the size of the timer queue, denoted as Size, minus ΔT. Initially, ΔT is zero so that when the first timer entry arrives, its time-to-live value is simply the size of the timer queue. For example, referring to FIG. 4A where the timer size is 100 seconds, the time-to-live value of the first timer entry is set to 100 seconds. The next step in block 510 sets ΔT equal to Size also indicates that various pointers need to be updated. For example, the tail pointer may be updated to reflect that a new timer entry has been added.

Discussed above are the steps in block 510 for an example case of entering a first timer entry into a timer queue. If control were brought to block 510 from some other flow path, for example for the case in which the timer queue already has a timer entry from a previous update, then the method 500 may perform other steps in block 510 such as updating various pointers to provide a doubly linked list.

Continuing with the method 500 illustrated in FIG. 5, assume by way of example that control is brought from block 510 to block 520. Then, at the next time update, ΔT is decremented by one, the time-to-live value for the head timer entry may be decremented by one, and control may be brought to block 522. Block 522 is shown to determine whether the time-to-live value is equal to zero. If it is equal to zero, then the head of the timer queue has expired, which progress the method 500 to block 524 where the memory location pointed to by the head pointer is returned to the free list, and control is brought to block 526. Block 526 determines whether the timer queue is empty or not. If the timer queue is empty, then control may be brought back to block 504. If, however, the timer queue is not empty, then control may be brought to block 528. In block 528, the head pointer is updated to point to the timer entry that was immediately after the previous expired head timer entry. Control may then brought to block 530.

Referring back to block 522, if the time-to-live value of the head timer entry is not equal to zero, then control is brought to block 530. Block 530 may determine whether a new timer entry is available. If it is not, then control is brought back to block 520 and the process just previously described occurs again. If, however, a new timer entry is available when block 530 is reached, then control is brought back to block 510 where the time-to-live value t for that new timer entry is set equal to Size−ΔT; ΔT is updated back to the timer size Size; and as indicated in block 510, the pointer to the tail of the timer queue is updated to reflect the new timer entry. Furthermore, other pointers need to be updated to maintain the timer queue as a doubly linked list.

In an example embodiment, blocks 504 and 520 should be executed at a rate at least as fast as the rate at which new timer entries are made available. The other blocks in FIG. 5 should be implemented faster than that rate so that the tail of the timer queue is always the most recent timer entry.

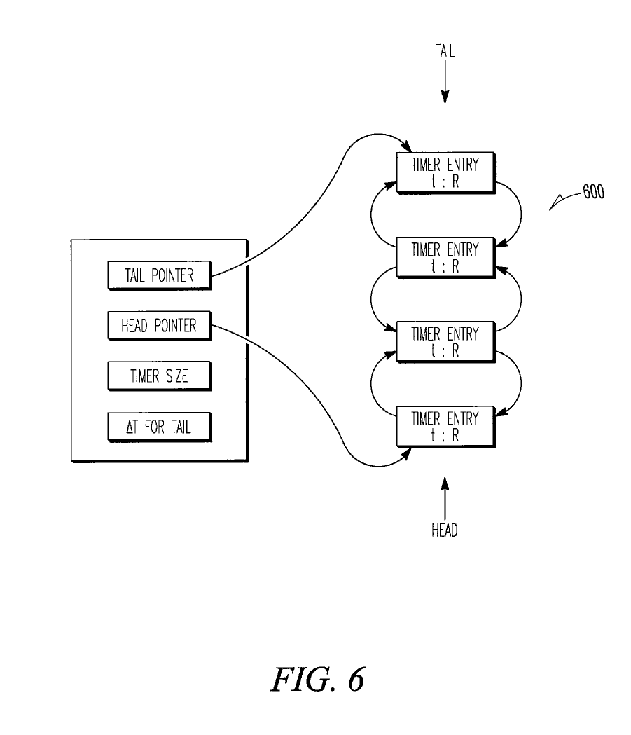

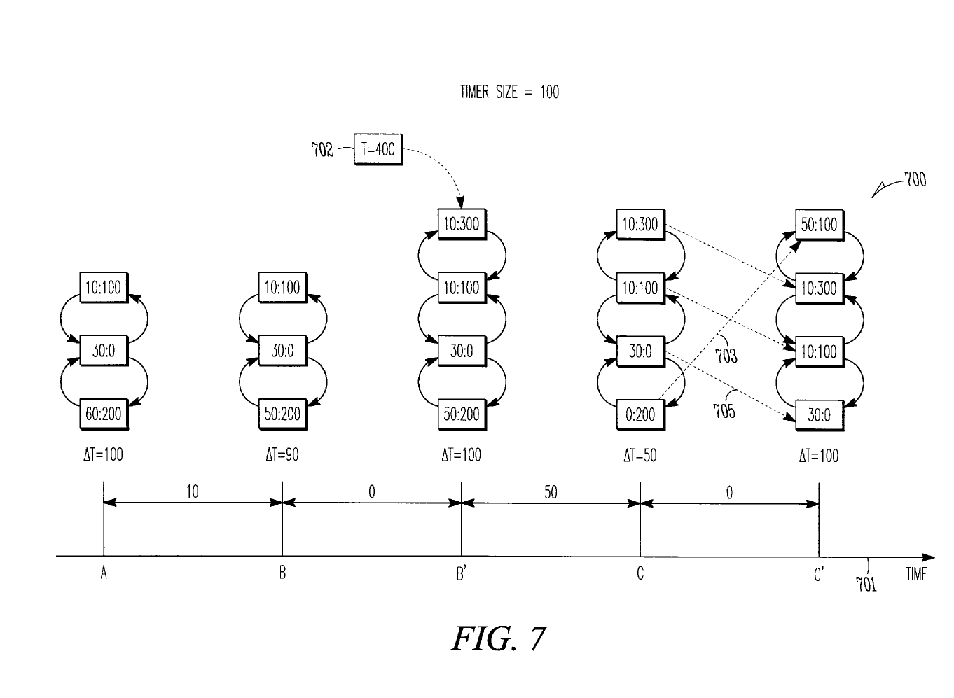

For the data structure described in reference to FIGS. 2, 3, 4A, 4B and 5, it has been assumed, by way of example, that each new timer entry has an expiration time that matches the timer size associated with the timer queue to which it is added. This restriction may be avoided by considering a new data structure, such as that illustrated in FIG. 6. This is similar to the data structure of FIG. 2, where t denotes the time-to-live value. However, each object in a timer queue 600 in FIG. 6 has an additional entry indicated by the letter R in FIG. 6. R represents a remainder, and for FIG. 6 it is assumed that each new timer entry that is to be added to the timer queue has an expiration time equal to a multiple of the timer size for that timer queue 600. When a new timer entry is added to the tail of the timer queue 600, its time-to-live value is set to the timer size associated with that timer queue 600, and its original expiration time is reduced by the timer size to yield the remainder. This is illustrated by way of example in FIG. 7.

FIG. 7 shows a timer queues 700 with respect to a time axis 701. In FIG. 7, it assumed by way of example the time size is 100 seconds. At time A there are shown to be three timer entry objects in the timer queue 700. The head timer entry has a time-to-live value of 60 seconds with a remainder of 200 seconds, and these values are indicated in FIG. 7 as 60:200. The next timer entry in the timer queue 700 at time A is shown to have a time-to-live value of 30 seconds and a remainder of zero. The tail of the timer queue 700 at time A has a time-to-live value of 10 seconds and a remainder of 100 seconds. It is assumed by way of example that at time A the tail was recently added so that ΔT was set to the size of the timer queue 700.

Suppose that at time B, 10 seconds has elapsed since time A. Then, ΔT is decremented down to 90 seconds, and the time-to-live value for the head of the timer queue 700 is reduced by 10 seconds down to 50 seconds. Suppose just after time B, a new timer entry, labeled 702, is to be added at time B′. Its expiration time, denoted by T, is 400 seconds, which is a multiple of the timer size. When this new timer entry is added to the timer queue 700 at the time event B′, it becomes the new tail for that timer queue 700. Just as for the previously described data structures, its time-to-live value is now relative to the timer entry ahead of it, which was the previous tail for the timer queue 700. Because ΔT is 90 seconds, the time-to-live value of the new timer entry is set to 10 seconds, and ΔT is updated to the timer size of 100 seconds. This new timer entry has a remainder of 300 seconds. This is so because in the given example the timer size is 100 seconds, and it should be indicated that when this timer entry moves to the head of the timer queue and its time-to-live value is decremented to zero, it really has not expired because there still is 300 seconds remaining.

Thus, there is the fiction of the data structure discussed previously in which every new timer entry has an expiration time that matches the timer size. However, when the timer entry reaches the head of the timer queue 700, and when its time-to-live value reaches zero, it does not actually expire if its remainder is not yet zero; but instead, it is recycled through the timer queue and its remainder is again reduced by an amount equal to the timer size. Eventually, when it is recycled enough times, its remainder will be zero, in which case when it reaches the head of the timer queue 700, and when its time-to-live value is decremented to zero, it now truly has expired. This is illustrated in the other time events indicated at time events labelled C and C′ in FIG. 7.

For example, at time event C, which occurs 50 seconds after the time event labeled B′, it is seen that ΔT has been reduced by 50 seconds down to a value of 50 seconds, and the time-to-live value of the head of the timer queue 700 has been reduced to zero; but because the remainder for that head is 200, that timer entry has not yet expired, and it is recycled to the tail of the timer queue 700 as a new timer entry. This is indicated as a dashed line 703 from the head of the timer queue at time event C to the tail of the timer queue at time event C′, where the time-to-live value of that new tail is now set to 50 seconds because ΔT at time C was 50. But, the remainder, which was 200 seconds when that timer entry was at the head of the timer queue 700 at time event C, is now reduced by the timer size down to 100 seconds as indicated at the tail of the timer queue 700 at the time event C′. Likewise, the timer entry, just above the head of the timer queue 700 at time C, now becomes the new head of the timer queue at time C′, as indicated by the dashed line 705. The other dashed lines indicate how the various objects assume new relative positions in the updated timer queue 700 at time event C′.

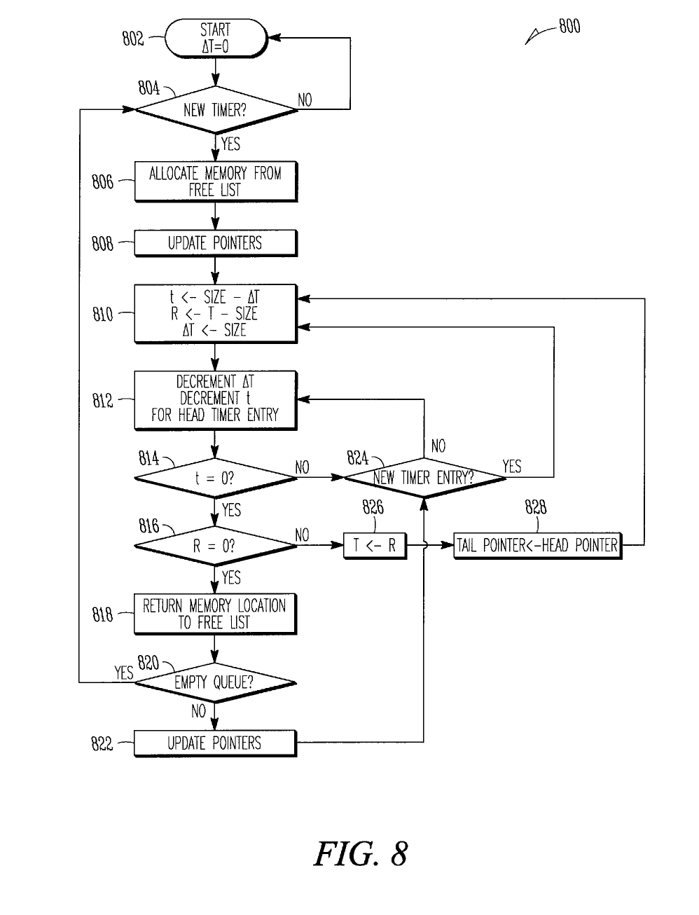

FIG. 8 shown a method 800, in accordance with an example embodiment, for updating a data structure. The method 800 may be used to update the data structure shown in FIG. 6 and, accordingly, is described by way of example with reference thereto. Similar to the method 500 shown in FIG. 5, the method may start at block 802, which indicates that the timer queue is empty and ΔT is set to zero. When the first timer entry arrives, control is brought to block 804 and then to block 806 where memory for the new timer entry is allocated from a free list. In block 808, the appropriate pointers, such as the head pointer and the tail pointer, are updated.

Control may then be brought to block 810. The time-to-live value is set equal to the timer size minus ΔT, just as in the method 500. Again, if this is a first timer entry, then ΔT was zero, in which case the time-to-live entry is the timer size. A new variable is introduced in FIG. 8, denoted by T, to represent the expiration time of the new timer entry. It is assumed by way of example that this expiration time T is equal to some multiple of the timer size. As indicated in block 810, the method 800 subtracts from this expiration time the timer size to arrive at a value for the remainder R. As before, in the last step in block 810, it is seen that ΔT is updated to the timer size.

Control may then be brought to block 812 where the time-to-live value of the head timer entry is decremented and ΔT is decremented. Now refer to block 814, which determines whether the time-to-live value of the head of the timer queue is zero or not. If it is zero, then in block 816 a determination is made as to whether the remainder is zero or not. If it is zero, then the head timer entry has expired, in which case the memory location for that timer entry is returned to the free list as indicated in block 818. In block 820, a determination is made as to whether the timer queue is empty or not. If it is empty, then control is brought back to block 804; but if the timer queue is not empty, then various pointers are updated to reflect the fact that there is now a new head timer entry in the timer queue, as indicated in block 822. After the head pointer is updated as indicated in block 822, control is brought to block 824.

Considering, for example, the case in which at block 814, the time-to-live value for the head timer entry of the timer queue is not zero, in which case control may be brought to block 824. Now, suppose at block 814 the time-to-live value is zero, but at block 816 it is determined that the remainder R is not zero. Then, there is still time remaining for the head timer entry, in which case one may set the expiration time T for the head timer entry to the then current remainder value R, as indicated in block 826. Control may then be brought to block 828, where it is seen that to update the timer queue so that what was once the head is now the tail, the tail pointer value is replaced with the head pointer value. Control is then brought back to block 810, which performs the steps as indicated in 810, and then the process just discussed repeats itself

As in regard to FIG. 5, some simplifications are applied in the example method 800 shown FIG. 8. For example, the case in which timer entries are cancelled when the corresponding acknowledgment packet is received is not covered. However, as discussed earlier, this may be handled in various ways. For example, nothing may be done to those particular timer entries which are no longer needed, other than to keep a list of those timer entries that are to be ignored when they expire. In an example embodiment, such timer entries may be actively cancelled by removing them from the timer queue, which involves a change in various pointers so that these cancelled timer entries are no longer in the doubly linked list that makes up the timer queue. Furthermore, as discussed by way of example with respect to FIG. 5, block 812 and block 804 in FIG. 8 should execute at a rate at least equal to that at which new timer entries are made available, whereas the remaining blocks should be implemented at a faster rate so that the tail of the timer queue is indeed the most recent timer entry.

So far, by way of example, there has been described data structures which either handle timer entries having an expiration time that match the timer size of the timer queue, as discussed with respect to FIG. 2, or for which the timer queue may accept timer entries having an expiration time equal to a multiple of the timer size of the timer queue, as discussed with respect to FIG. 6. But, by employing a multiple number of data structures, as indicated in FIG. 6, it may be possible to devise data structures that may handle timer entries with expiration times that do not necessarily match the timer size or do not necessarily match a multiple of the timer size. That is, the time expiration may be arbitrary.

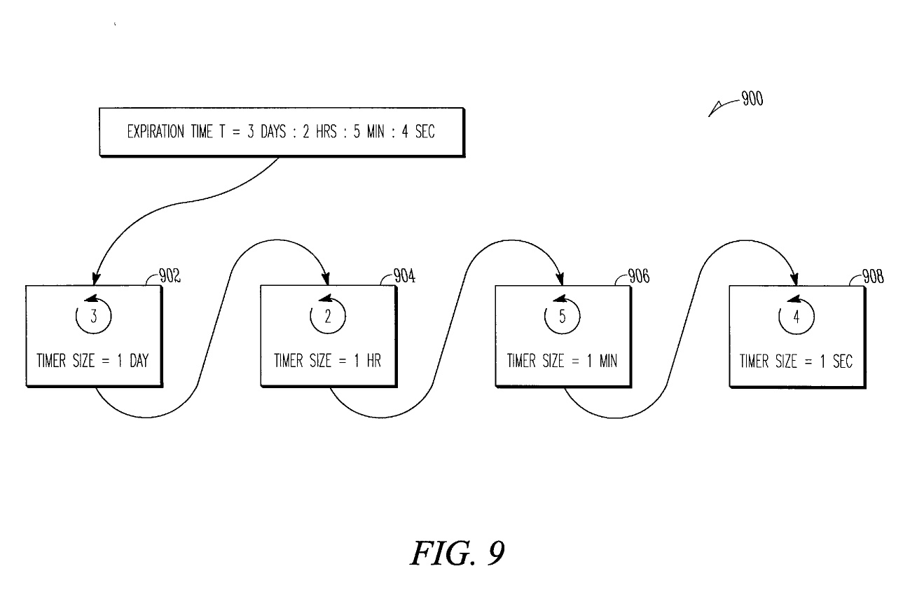

FIG. 9 illustrates a timer 900 employing multiple timer queues according to an example embodiment. In this example embodiment, it is assumed by way of example that there are four timer queues where a timer queue 902 has a timer size of one day, a timer queue 904 has a timer size of one hour, a timer queue 906 has a timer size of one minute, and a timer queue 908 has a timer size of one second. Further it is assumed by way of example that one second is the granularity for this particular example, so that one need not consider timer sizes less than one second. Now suppose there is a new timer entry that has an expiration time of three days, two hours, five minutes and four seconds. In this case, the timer entry may be represented as having an expiration time T as 3:2:5:4. When this timer entry arrives, it is put at the tail of the timer queue in block 902.

Assuming that this timer entry is not cancelled, it will cycle through the timer queue 902 for a total of three times, where the timer queue 902 may have the data structure indicated in FIG. 6. Each time this timer entry cycles through the timer queue, its expiration time is effectively reduced by one day. That is, its remainder R is reduced by one day. Assuming again that this timer entry is not cancelled, if it reaches the head of the timer queue in block 902 with its time-to-live value equal to zero and its remainder less than one day, then it is transferred over to the timer queue in block 904. It then becomes a new timer entry for the timer queue of block 904, in which case it is placed at the tail such that its expiration time is now two hours, five minutes and four seconds.

When this timer entry enters the tail of the timer queue in block 904, it will now cycle through that timer queue for a total of two times, so that on the second time, again assuming that it is not cancelled, its time-to-live value will be zero and its remainder will be less than one hour. It then is transferred to the timer queue in block 906, where its expiration time is 5 minutes and four seconds. It will now cycle through the timer queue of block 906 five times before being transferred to the tail of the timer queue of block 908. Again, assuming that this timer entry is not cancelled, it will cycle through the timer queue of block 908 for a total of four times before it finally expires.

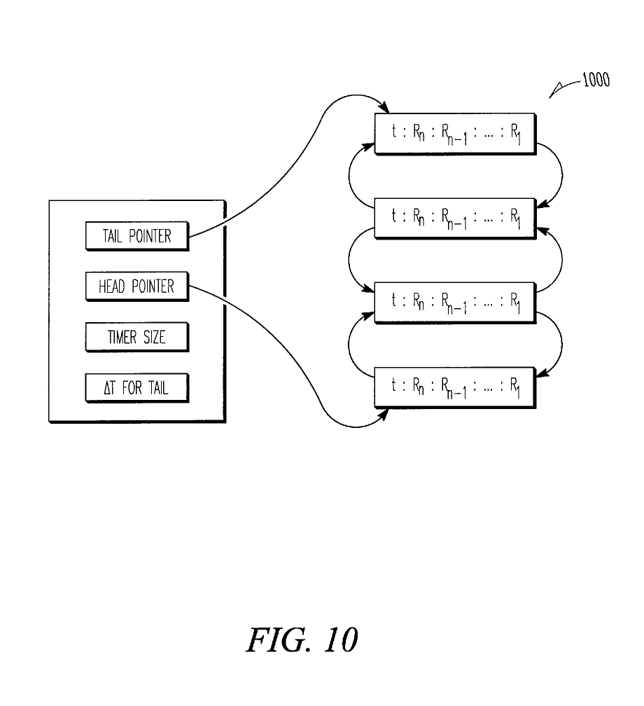

In light of the above, the data structure indicated in FIG. 6 may be modified to the data example structure indicated in FIG. 10. In FIG. 10, each timer entry object in a timer queue 1000 has a remainder that is written in a representation dependent upon the timer sizes. In other words, the remainder may be written in the “number base” of the timer sizes. For example, for FIG. 9 there are four example timer queues 902, 904, 906 and 904 where the timer size of timer queue 902 is one day, the timer size of timer queue 904 is one hour, the timer size of timer queue 906 is one minute, and the timer size of timer queue 908 is one second. Using that example representation, any time value may be represented, assuming a granularity of one second, in terms of those particular time sizes. For example, as discussed by way of example with regard to FIG. 9, the new timer entry was represented as having an expiration time of 3:2:5:4.

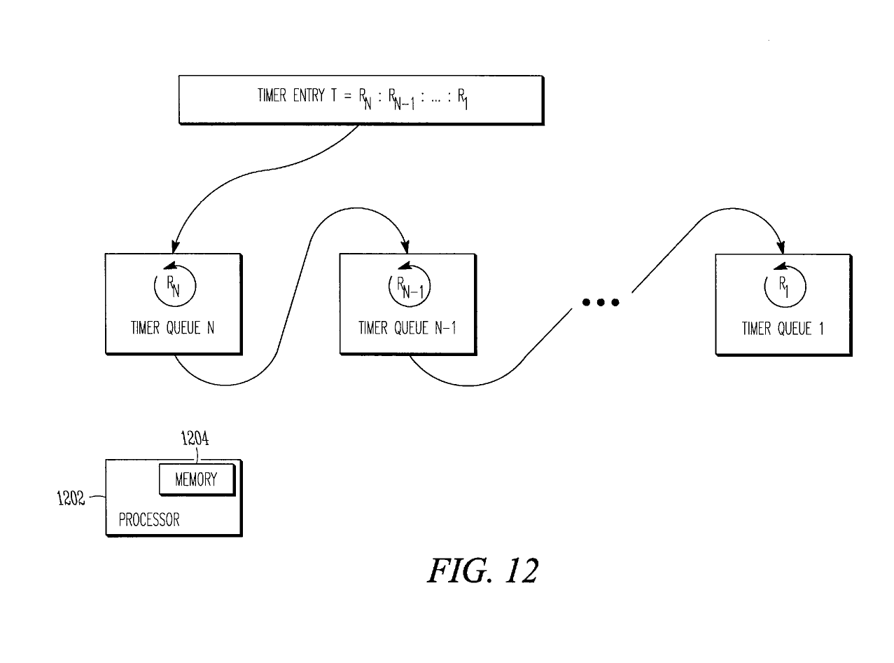

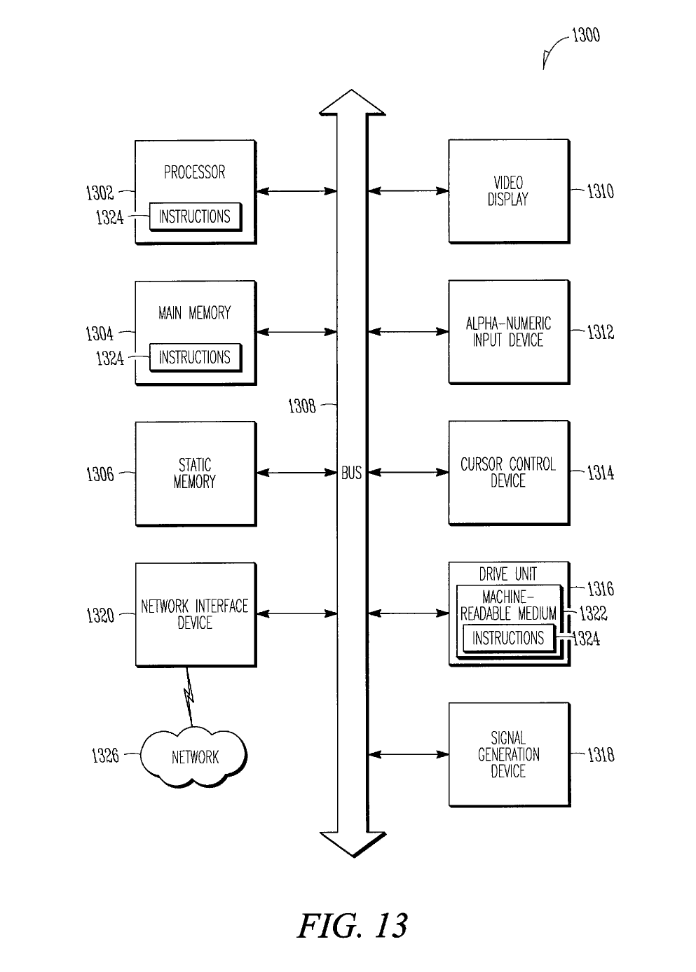

For a data structure comprising a plurality of timer queues, each timer queue may be labelled by an index m. For example, in FIG. 12, “TIMER QUEUE m” is a label for a timer queue with an index m. Without loss of generality, the index m ranges over the integers 1 through N, that is, m=1,2, . . . , N. The timer size for timer queue TIMER QUEUE m is Size(m). An expiration time, or remainder, may be represented by the string of digits R_{N}: R_{N-1}: . . . :R₁, where the expiration time, or remainder, is the sum

R_{N}·Size(N)+R_{N-1}·Size(N−1)+ . . . +R₁·Size(1).

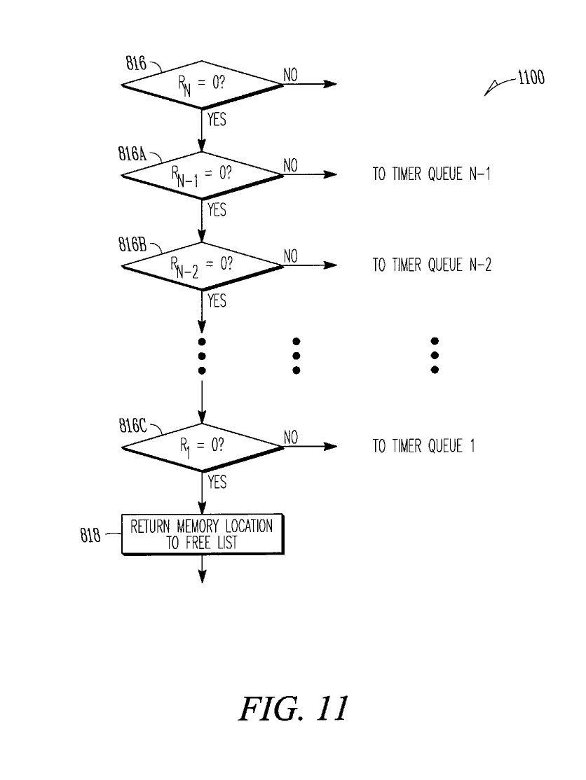

For example, in FIG. 9 the index for the timer queue 902 may be written as 4, the index for timer queue 904 as 3, the index for timer queue 906 as 2, and the index for timer queue 908 as 1. When a new timer entry first enters as a tail to timer queue TIMER QUEUE m, it may be updated according to the method 800 shown in FIG. 8, but now Rₘ is decremented each time the timer entry cycles through timer queue TIMER QUEUE m. When Rₘ reaches zero, it is then passed off to the next lower-indexed timer queue, timer queue TIMER QUEUE m−1, which now decrements Rₘ₋₁. As a result, the method 800 should be modified as indicated by the partial method 1100 shown in the flow diagram of FIG. 11.

Referring now to FIG. 11, blocks labeled 816, 818 and 826 may be essentially the same as the correspondingly labeled blocks in FIG. 8. However, now the remainder may be indexed as indicated in FIG. 11. Between blocks 816 and 818 are inserted a number of blocks equal in number to the other remaining timer queues lower in index than the particular timer queue illustrated in FIG. 11. For ease of illustration, only three blocks, blocks 816A, 816B and 816C, are shown explicitly. For each such block, a decision is made as to whether its corresponding remainder digit is equal to zero or not. For example, if in block 816 it is determined that the remainder R_{N} is equal to zero, then control is brought to block 816A, where a decision is made as to whether the next remainder digit, R_{N-1}, is equal to zero. If it is not equal to zero, then that timer entry is given to the next lower index timer queue, timer queue TIMER QUEUE N−1. If, however, in block 816A it is determined that the remainder R_{N-1} is equal to zero, then control is brought to block 816B, in which case the next lower-indexed remainder, R_{N-1}, is investigated. This proceeds until the entire generalized remainder has been investigated.

This procedure is illustrated by way of example in FIG. 12 where there are N timer queues, and for simplicity only three timer queues, timer queue TIMER QUEUE N, TIMER QUEUE N−1, and TIMER QUEUE1 are shown. There are of course also other components to the data structures such as the register files, which contain all the various pointers to keep track of the various timer queues. These register files may reside in processor 1202, for example. The processor 1202 may also comprise the code in memory 1204 for updating the various timer queues and pointers.

Assuming by way of example that a new timer entry is available with an expiration time T, which may be represented by R_{N}:R_{N-1}: . . . R₁. When the new timer entry is added to TIMER QUEUE N at its tail, it will cycle through for a total of R_{N} times, after which it will then be transferred to the next timer queue, TIMER QUEUE N−1, assuming that R_{N-1} is not zero. It will then cycle through TIMER QUEUE N−1 for a total of R_{N-1} times, be transferred to the next timer queue and cycled accordingly, and so forth, until finally it is transferred to TIMER QUEUE1, where it will cycle through for a total of R₁ times.

The above example embodiment is simplified if it is to be understood that cycling a timer entry through TIMER QUEUE m for a total of Rₘ times for the case in which Rₘ=0 may mean that the timer entry is not cycled through TIMER QUEUE m. Accordingly, if for some index m a remainder digit Rₘ is zero, then the correspondingly indexed timer queue is skipped. (It is also assumed in this example embodiment that the timer entries were not cancelled. If a timer entry is cancelled, then it would not need to cycle through any remaining timer queues.)

In some embodiments one may choose the timer sizes to be powers of two so that the remainder digits R_{N}:R_{N-1}: . . . R₁ are simply the binary digits 0 or 1. In such a case, each timer entry will cycle through a particular timer queue at most only once.

The example data structure indicated in FIG. 10 may be replicated to create a plurality of timer queues as shown by way of example in FIG. 12, so that timer entries having arbitrary time expirations may be processed in an efficient manner without requiring walking through a linked list as done in the prior art data structure of FIG. 1.

Thus N data structures TIMER (m) may be considered, where m=1,2, . . . , N, where each data structure TIMER (m) comprises the linked list TIMER QUEUE m to which there is an associated timer size Size(m) and a time value ΔT(m).

It is instructive to summarize example relationships between expiration time, remainder, time-to-live value, timer size, and time value ΔT, as described by way of example in the above embodiments. When a timer entry has not yet entered any timer data structure, it has some expiration time. It may be added to the timer queue having the largest timer size not exceeding its expiration time. When added, it is added at the tail of the timer queue, with a time-to-live value chosen so that all time-to-live values of the timer entries in the timer queue sum to the size of the timer queue. At any give time, the time value ΔT may keep track of the sum of the time-to-live values. When the timer entry is first added at the tail, its time-to-live value is easily found by subtracting the current time value ΔT from the timer size. The time-to-live value for a newly added timer entry is therefore relative to any immediately prior timer entry in the timer queue. When the timer entry is added, the time value ΔT is re-set to the timer size. Furthermore, when the timer entry is first added, its expiration time may be reduced by the timer size. This reduced expiration time is referred to as a remainder.

As real time progresses, in an example embodiment the time-to-live value of the head of each timer queue, and its associated time value ΔT, are decremented. A timer entry is removed from the head of a timer queue when its time-to-live value is zero. Now, regarding the timer entry that was newly added for the first time, when it reaches the head and its time-to-live value is zero, it is then cycled back to the tail of the same timer queue if its remainder (reduced expiration time) is equal to or greater than the timer size. If it is added again to the tail of the same timer queue, the same steps as discussed above may be repeated, where its remainder is reduced by the timer size, and so forth. But if after being removed from the head its remainder is less than the timer size, then may be transferred to any remaining timer queue having the largest timer queue size not exceeding the remainder.

Instructions for implementing embodiments of the present invention may reside on various processor readable media, such as system memory, on-chip memory, or other types of media, such as a storage device.

FIG. 13 shows a diagrammatic representation of a machine in the form of computer system 1300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1300 includes processor 1302 (e.g., a central processing unit (CPU), a graphics processing unit (GPU) or both), main memory 1304, and static memory 1306, which communicate with each other via bus 1308. In other embodiments, bus 1308 my be generalized to other types of communication systems, such as a point-to-point communication system. Computer system 1300 may further include video display unit 1310 (e.g., liquid crystal display (LCD) or cathode ray tube (CRT)). Computer system 1300 may also include alphanumeric input device 1312 (e.g., a keyboard), user interface (UI) navigation device 1314 (e.g., a mouse), disk drive unit 1316, signal generation device 1318 (e.g., a speaker), and network interface device 1320.

Disk drive unit 1316 includes machine-readable medium 1322 on which is stored one or more sets of instructions and data structures (e.g., software 1324) embodying or utilized by any one or more of the methodologies or functions described herein. Software 1324 may also reside, completely or at least partially, within main memory 1304 and (or) within processor 1302 during execution thereof by computer system 1300, so that either main memory 1304 or processor 1302 may be regarded as comprising machine-readable media.

Software 1324 may further be transmitted or received over network 1326 via network interface device 1320 utilizing any one of a number of well-known transfer protocols (e.g., HTTP).

It should be clear that many variations and modifications may be made to the disclosed embodiments without departing from the scope of the invention. For example, in the data structure in FIG. 10, the generalized remainder is represented as a sequence of digits within the number base represented by the various timer sizes of the timer queues. However, that is just one implementation. In other embodiments, the remainder may simply be represented as a number irrespective of the timer sizes, in which case the flow diagram of FIG. 11 is modified where in block 816, instead of comparing whether R_{N} is equal to zero or not, a comparison is made to the remainder itself as to whether it is greater than or not the timer size. If it is less than the timer size, then it needs to be transferred to one of the other lower-sized timer queues. This effectively replaces the sequence of blocks indicated by 816A, 816B and 816C in FIG. 11, so that the net result is the same flow of a timer entry through various timer queues. All that has really changed is the particular representation of the remainder.

In this description of the embodiments, the concept of a remainder was introduced to account for the expiration time when reduced by a timer queue size. This was done for ease of discussion. One may consider the remainder to be merely a newly computed expiration time, where it represents any actual expiration time remaining on a timer entry once it has been removed from the head of a timer queue. Accordingly, in the claims, the term remainder is not needed, but rather, reference is made to expiration time. When an expiration time is reduced by a timer queue size, it is immaterial whether it is henceforth referred to as an expiration time or a remainder.

1. A computer readable medium comprising instructions to process timer entries, each timer entry having an expiration time, the instructions, when executed by a computer, cause the computer to:
create a data structure comprising:
a linked list of timer entries, the linked list having a head and a tail; and
a timer size; and
add each timer entry to the linked list only at the tail and only if the expiration time of the added timer entry is equal to or greater than the timer size.

2. The computer readable medium as set forth in claim 1, wherein each timer entry has a time-to-live value, the data structure comprising a time value equal to a sum of the time-to-live values of each timer entry in the linked list if the linked list is not empty, the instructions causing the computer to:
for each timer entry added to the tail, decrement its expiration time by the timer size and set the time value to the timer size.

3. The computer readable medium as set forth in claim 2, which causes the computer to:
remove a timer entry from the head if its time-to-live value is zero.

4. The computer readable medium as set forth in claim 3, which causes the computer to:
return a timer entry to the tail when it has been removed from the head and if its expiration time is greater than or equal to the timer size.

5. The computer readable medium as set forth in claim 1, wherein each timer entry has a time-to-live value, the instructions causing the computer to:
remove a timer entry from the head if its time-to-live value is zero.

6. The computer readable medium as set forth in claim 1, wherein each timer entry has a time-to-live value, and wherein for each timer entry added to the linked list having an expiration time equal to the timer size, the expiration time equals the time-to-live value.

7. The computer readable medium as set forth in claim 1, wherein the head and the tail are the same object if the linked list comprises exactly one timer entry.

8. A computer readable medium comprising instructions to process timer entries, each timer entry having a time-to-live value, the instructions when, executed by a computer, cause the computer to:
create a data structure comprising:
a linked list of timer entries, the linked list having a head and a tail; and
a timer size; and
add each timer entry to the linked list only at the tail and only if the time-to-live value of each added timer entry is equal to the timer size.

9. The computer readable medium as set forth in claim 8, wherein the data structure comprises a time value equal to a sum of the time-to-live values of each timer entry in the linked list if the linked list is not empty, the instructions causing the computer to:
set the time value to the timer size each time a timer entry is added to the tail.

10. The computer readable medium as set forth in claim 8, which causes the computer to:
remove a timer entry from the head if its time-to-live value equals zero.

11. The computer readable medium as set forth in claim 8, wherein the head and the tail are the same object if the linked list comprises exactly one timer entry.

12. A method to process timer entries, the method comprising:
creating a data structure comprising:
a linked list of timer entries, the linked list having a head and a tail; and
a timer size; and
adding each timer entry to the linked list only at the tail and only if the expiration time of the added timer entry is equal to or greater than the timer size.

13. The method as set forth in claim 12, the data structure comprising a time value equal to a sum of the time-to-live values of each timer entry in the linked list if the linked list is not empty, the method further comprising:
for each timer entry added to the tail, decrementing its expiration time by the timer size and setting the time value to the timer size.

14. The method as set forth in claim 13, further comprising:
removing a timer entry from the head if its time-to-live value is zero.

15. The method as set forth in claim 14, further comprising:
returning a timer entry to the tail when it has been removed from the head and if its expiration time is greater than or equal to the timer size.

16. The method as set forth in claim 12, each timer entry having a time-to-live value, the method further comprising:
removing a timer entry from the head if its time-to-live value is zero.

17. The method as set forth in claim 12, each timer entry having a time-to-live value, wherein for each timer entry added to the linked list having an expiration time equal to the timer size, the expiration time equals the time-to-live value.

18. The method as set forth in claim 12, wherein the head and tail are the same object if the linked list comprises exactly one timer entry.

19. A method to process timer entries, each timer entry having a time-to-live value, the method comprising:
creating a data structure comprising:
a linked list of timer entries, the linked list having a head and a tail; and
a timer size; and
adding each timer entry to the linked list only at the tail and only if the time-to-live value of each added timer entry is equal to the timer size.

20. The method as set forth in claim 19, the data structure comprising a time value equal to a sum of the time-to-live values of each timer entry in the linked list if the linked list is not empty, the method further comprising:
setting the time value to the timer size each time a timer entry is added to the tail.

21. The method as set forth in claim 19, further comprising:
removing a timer entry from the head if its time-to-live value equals zero.

22. The method as set forth in claim 19, wherein the head and the tail are the same object if the linked list comprises exactly one timer entry.

23. A method comprising:
creating N data structures TIMER (m), where m=1, 2, . . . , N, where for each m=1, 2, . . . , N the data structure TIMER (m) comprises a linked list TIMER QUEUE m to store timer entries and to which there is an associated timer size Size(m), where each timer entry has an expiration time, the linked list TIMER QUEUE m having a tail and a head;
for each m=1, 2, . . . , N, adding a timer entry, having an expiration time of Rₘ·Size(m)+Rₘ₋₁·Size(m−1)+ . . . +R₁·Size(1), to the tail of TIMER QUEUE m only if Rₘ≠0; and
for each m=1, 2, . . . , N, reducing by Size(m) the expiration time of a timer entry when removed from the head of TIMER QUEUE m.

24. The method as set forth in claim 23, each timer entry having a time-to-live value, wherein for each m=1, 2, . . . , N there is associated with TIMER QUEUE m a time value ΔT(m) equal to the sum of the time-to-live values of each timer entry in the TIMER QUEUE m, the method further comprising:
setting, for each m=1, 2, . . . , N, ΔT(m)=Size(m) when a timer entry is added to the tail of TIMER QUEUE m.

25. The method as set forth in claim 24, wherein for each m=1, 2, . . . , N, a timer entry is removed from the head of TIMER QUEUE m if its time-to-live value is zero, and is cycled back to the tail of TIMER QUEUE m only if Rₘ≠0.

26. The method as set forth in claim 23, wherein for each m=1, 2, . . . , N, the tail and head of TIMER QUEUE m are the same object if TIMER QUEUE m comprises exactly one timer entry.

27. A computer readable medium comprising instructions which, when executed by a computer, causes the computer to:
create N data structures TIMER (m), where m=1, 2, . . . , N, where for each m=1, 2, . . . , N the data structure TIMER (m) comprises a linked list TIMER QUEUE m to store timer entries and to which there is an associated timer size Size(m), where each timer entry has an expiration time, the linked list TIMER QUEUE m having a tail and a head;
for each m=1, 2, . . . , N, add a timer entry, having an expiration time of Rₘ·Size(m)+Rₘ₋₁·Size(m−1)+ . . . +R₁·Size(1), to the tail of TIMER QUEUE m only if Rₘ≠0; and
for each m=1, 2, . . . , N, reduce by Size(m) the expiration time of a timer entry when removed from the head of TIMER QUEUE m.

28. The computer readable medium as set forth in claim 27, wherein each timer entry having a time-to-live value, wherein for each m=1, 2, . . . , N there is associated with TIMER QUEUE m a time value ΔT(m) equal to the sum of the time-to-live values of each timer entry in the TIMER QUEUE m, the instructions causing the computer to:
set, for each m=1, 2, . . . , N, ΔT(m)=Size(m) when a timer entry is added to the tail of TIMER QUEUE m.

29. The computer readable medium as set forth in claim 28, wherein for each m=1, 2, . . . , N, a timer entry is removed from the head of TIMER QUEUE m if its time-to-live value is zero, and is cycled back to the tail of TIMER QUEUE m only if Rₘ≠0.

30. The computer readable medium as set forth in claim 27, wherein for each m=1,2, . . . ,N, the tail and head of TIMER QUEUE m are the same object if TIMER QUEUE m comprises exactly one timer entry.

31. A system comprising:
means for creating N data structures TIMER (m), where m=1, 2, . . . , N, where for each m=1, 2, . . . , N the data structure TIMER (m) comprises a linked list TIMER QUEUE m to store timer entries and to which there is an associated timer size Size(m), where each timer entry has an expiration time, the linked list TIMER QUEUE m having a tail and a head;
for each m=1, 2, . . . , N, means for adding a timer entry, having an expiration time of Rₘ·Size(m)+Rₘ₋₁·Size(m−1)+ . . . +R₁·Size(1), to the tail of TIMER QUEUE m only if Rₘ≠0; and
for each m=1, 2, . . . , N, means for reducing by Size(m) the expiration time of a timer entry when removed from the head of TIMER QUEUE m.

32. The system as set forth in claim 31, each timer entry having a time-to-live value, wherein for each m=1, 2, . . . , N there is associated with TIMER QUEUE m a time value ΔT(m) equal to the sum of the time-to-live values of each timer entry in the TIMER QUEUE m, the system further comprising:
means for setting, for each m=1, 2, . . . , N, ΔT(m)=Size(m) when a timer entry is added to the tail of TIMER QUEUE m.

33. The system as set forth in claim 32, wherein for each m=1, 2, . . . , N, a timer entry is removed from the head of TIMER QUEUE m if its time-to-live value is zero, and is cycled back to the tail of TIMER QUEUE m only if Rₘ≠0.

34. The system as set forth in claim 31, wherein for each m=1, 2, . . . , N, the tail and head of TIMER QUEUE m are the same object if TIMER QUEUE m comprises exactly one timer entry.

35. A system comprising:
a first memory;
a second memory; and
a processor to:
store in the first memory N data structures TIMER (m), where m=1, 2, . . . , N, where for each m=1, 2, . . . , N the data structure TIMER (m) comprises a linked list TIMER QUEUE m to store timer entries, where each timer entry has an expiration time, the linked list TIMER QUEUE m having a tail and a head;
store in the second memory a timer size Size(m) associated with the linked list TIMER QUEUE m;
for each m=1, 2, . . . , N, add a timer entry, having an expiration time of Rₘ·Size(m)+Rₘ₋₁·Size(m−1)+ . . . +R₁·Size(1), to the tail of TIMER QUEUE m only if Rₘ·0; and
for each m=1, 2, . . . , N, reduce by Size(m) the expiration time of a timer entry when removed from the head of TIMER QUEUE m.

36. The system as set forth in claim 35, each timer entry having a time-to-live value, wherein for each m=1, 2, . . . , N the processor stores in the second memory a time value ΔT(m) associated with TIMER QUEUE m equal to the sum of the time-to-live values of each timer entry in the TIMER QUEUE m, the processor further setting, for each m=1, 2, . . . , N, ΔT(m)=Size(m) when a timer entry is added to the tail of TIMER QUEUE m.

37. The system as set forth in claim 36, wherein for each m=1, 2, . . . , N, the processor removes a timer entry from the head of TIMER QUEUE m if its time-to-live value is zero, and is cycled back to the tail of TIMER QUEUE m only if Rₘ≠0.

38. The system as set forth in claim 35, wherein for each m=1, 2, . . . , N, the tail and head of TIMER QUEUE m are the same object if TIMER QUEUE m comprises exactly one timer entry.

39. The system as set forth in claim 35, the processor comprising a register file, wherein the register file comprises the second memory.

40. The system as set forth in claim 35, further comprising a third memory comprising the first memory and the second memory.
